(19) United States
(12) Patent Application Publication
(10) Pub. No.: US 2020/0361357 A1
(43) Pub. Date: Nov. 19, 2020

(54) Apparatuses, Systems, and Methods for the Safe Disposal of Concrete Washout

(71) Applicant: Joseph Salomone, Pompton Plains, NJ (US)

(72) Inventor: Joseph Salomone, Pompton Plains, NJ (US)

(21) Appl. No.: 16/415,737

(22) Filed: May 17, 2019

(51) Int. Cl. B60P 1/64; B08B 17/02; B60P 7/13

(52) U.S. Cl. CPC B60P 1/6454; B60P 7/13; B08B 17/025

(57) ABSTRACT

Systems and methods for improved removal and disposal of concrete waste by using a washout container on a roll-off truck, whereby the washout container may include a cradle and liner that are both durable and easy to maintain.

### FIELD OF THE INVENTION

This invention relates to apparatuses, systems and methods for the safe removal and disposal of concrete waste and washout that overcome various shortcomings in previous systems and methods. Specifically, a concrete washout collection truck incorporating a novel combination of components including a multi-piece washout container and a vacuum module is disclosed. These novel components allow for new and improved residue collection methods, including the siphoning of liquid waste and solid concrete washout by a single truck.

### BACKGROUND OF THE INVENTION

Concrete, cement and related products are used in the construction industry to form concrete structures or to form both exterior and interior wall surfaces. The tools and machinery used in these processes needs to be cleaned after each use. In the course of a large construction project, these repeated washings produce substantial quantities of highly caustic liquid residue that then needs to be safely contained to limit any harm to the environment.

Concrete is a standard building material made by mixing a cementing material (such as Portland cement) and a mineral aggregate (such as sand and gravel) with sufficient water to cause the cement to set and bind the entire mass. Concrete is typically carried to job sites in transit mixer trucks and may be moved within the site with concrete pump trucks. When pumping or pouring is complete, a small amount of concrete will remain in the trucks, while concrete residue will remain on the tools and equipment used during the process. If any excess concrete and concrete residue is not quickly removed, the concrete will harden. At best, this will significantly complicate the cleanup process. At worst, it will result in damage to the equipment. Therefore, the mixer and pump portions of the truck along with concrete finishing tools must be washed off at the job site after pouring or pumping concrete to allow continued use of the equipment.

Once hardened, concrete is inert and harmless to the environment. However, the same is not true for the water used to cure concrete, or to clean equipment used to deliver and place concrete. If not properly isolated, this wastewater can leach into groundwater, raising pH and heavy metal levels, both of which can be harmful to living organisms. Therefore, primarily due to environmental concerns and requirements, the waste, or washout, is commonly drained into a pit lined with a waterproof sheet.

Typically, a concrete pump truck is equipped with a plug that may be removed from the bottom of the concrete pump, allowing water and waste concrete to drain into the disposal pit. Parts of the truck in contact with concrete are then washed, usually with a hose, to remove concrete residue. A similar operation is performed for transit mixer trucks, and any other equipment and tools used to handle the concrete. The wastewater remains on top of the pit while the heavier concrete components sink to the bottom. Over time, the waste concrete components solidify. They can then be removed from the pit and transported to a permanent disposal site.

There are a number of problems with this traditional approach. First, it is labor intensive. A pit (or pits, depending on the size of the project) must be dug and then lined. Then, regardless of when the pit is full, the waste concrete material must be allowed to harden before it can be loaded and transported to the disposal site. Second, spills are almost unavoidable while dumping the waste concrete into the pit and washing the equipment. Third, even when crews are careful, damage to the plastic liner—allowing caustic wastewater to leak out of the pit and into groundwater—was common.

The improper disposal of wastewater has serious health implications, including gastrointestinal illness, reproductive problems, and neurological disorders. Infants, young children, the elderly and people with compromised immune systems are particularly at risk. Numerous federal, state and local regulations have been enacted to address wastewater disposal issues. For example, the Clean Water Act, 40 CFR, Subchapters D, N and O, non-compliance can result in civil (fines) and criminal (incarceration) penalties.

A number of containment structures and methods of disposal have been proposed to collect and confine contaminated wash residues, including U.S. Pat. No. 5,547,312 (“Schmitz, Jr.”); U.S. Pat. No. 6,648,008 (“Price”); U.S. Pat. No. 5,099,872 (“Tarvin et al.”); U.S. Pat. No. 7,117,995 (“Connard III”); U.S. Pat. No. 6,866,047 (“Marvin”); U.S. Pat. No. 7,121,288 (“Jenkins”); U.S. Appln. No. 2007/0272303 (“Vizl”); and U.S. Appln. No. 2006/0059653 (“Mickelson”). These references generally describe either a portable wash collection assembly or a deployable structure that sometimes includes an elastic or compliant containment membrane that is laid on the ground to provide an erectable peripheral barrier for confining the draining wastewater while such are concurrently pumped out into a collection container for disposal. While suitable for the purposes intended, these prior art structures have significant drawbacks.

Jenkins discloses a washout container for collecting mixtures of solid and liquid waste materials, such as a mixture of waste concrete (slag) and water from cleaning concrete residues from vehicles and tools. Once waste materials, such as concrete slag and washout water, is collected, the liquid portion may be periodically removed from the washout container making room for additional waste material. The liquid may be pumped into a container vehicle for proper recycling or disposal. By pumping off excess liquid, the washout container need not be hauled away until solid material has sufficiently built-up in the container to limit the space available for further disposal. The container may then be collected by a different vehicle and the built-up solids dumped out of the washout container. Jenkins also discloses attaching ramps to the washout container to facilitate extending a portion of mixer trucks over the washout container for emptying waste materials and cleaning the trucks. Among numerous other problems (including cost), Jenkins' process for attaching the ramps is labor intensive and failing to attach to ramps properly could result in damage to the trucks and/or spillage of waste material at the construction site.

Vizl describes a generally rectangular containment structure having a transversely aligned intermediate wall separating the containment structure into a covered front portion and an open rear portion. The wall includes vertical tubular housings which each have a slot extending into the open rear portion and a slot extending into the covered front portion, forming a liquid communication path thereacross. A set of filter assemblies are located in the housings to limit transfer of larger sized particulates of the aggregate. According to Vizl, the wall and filter arrangement may be used to separate the diluted concrete paste from the aggregate, thereby simplifying the removal and disposal of the inert and massive part of the wash product while the caustic hydroxide parts of the hydration reaction are separately collected for neutralization and disposal. The covered front portion is provided with a pump-out port which may be periodically connected to a powered pump that transfers its caustic contents into drums to be thereafter neutralized and disposed. However, a container having a transverse wall and tubular housings as disclosed in Vizl is far more difficult and expensive to construct than typical containers. Also, the filters would need to be installed and periodically replaced, further adding to the cost to build and maintain the containment structure.

The above systems and methods also provided limited options for collecting wash out and wash-out containers. When a wash-out container is ready to be removed from a construction site, two trucks may be sent to collect the container. A first truck may be used to pump out the liquid, accumulated at the top of the container. A second truck may then collect the wash-out container with the residual solid concrete. Preparing and coordinating the two trucks, and hiring drivers to operate the two trucks is inefficient and costly.

Mickelson at least provides a truck mounted liquid concrete waste vacuum system with a storage tank adapted to be used in conjunction with a watertight concrete washout bin. The concrete washout bin is configured to roll off a transport vehicle for delivery to a construction site and to contain all solid and liquid concrete washout waste from construction activities. When the concrete washout waste is to be removed from the site, the liquid concrete waste vacuum system attached to the transport vehicle is first used to remove the liquid waste from the washout bin and store it in the tank. The bin containing the remaining solid waste is loaded on the transport vehicle and taken to the treatment facility where both the solid and liquid waste is safely off-loaded. So while Mickelson does present an all-in-one option, a principal problem with Mickelson's truck is that it is almost prohibitively expense to produce.

A need exists for systems and methods for facilitating concrete disposal that allows convenient emptying and cleaning of waste concrete from concrete mixing, hauling, and/or concrete application equipment without subjecting the environment to contamination hazards. The present invention satisfies those needs, as well as others, and overcomes the deficiencies of previously developed concrete disposal solutions.

### SUMMARY OF THE INVENTION

The present invention is directed to improved apparatuses and methods for collecting and transporting concrete washout.

It is an object of the present invention to reduce the number of roll-off trucks and truck operators required to collect concrete washout from a construction site.

It is a further object of the present invention to provide on a roll-off truck a vacuum module capable of emptying the contents of a vacuum tank to either side of the truck.

It is a further object of the present invention to provide ramps integrated with a concrete container to reduce the time and labor required to prepare the ramps, and reduce the incidents of accidents resulting from improper preparation of ramps.

Numerous variations may be practiced in the preferred embodiment.

### BRIEF DESCRIPTION OF THE DRAWINGS

A further understanding of the invention can be obtained by reference to embodiments set forth in the illustrations of the accompanying drawings. Although the illustrated embodiments are merely exemplary of apparatuses, systems, and methods for carrying out the invention, both the organization and method of operation of the invention, in general, together with further objectives and advantages thereof, may be more easily understood by reference to the drawings and the following description. Like reference numbers generally refer to like features (e.g., functionally similar and/or structurally similar elements).

The drawings are not necessarily depicted to scale; in some instances, various aspects of the subject matter disclosed herein may be shown exaggerated or enlarged in the drawings to facilitate an understanding of different features. Also, the drawings are not intended to limit the scope of this invention, which is set forth with particularity in the claims as appended hereto or as subsequently amended, but merely to clarify and exemplify the invention.

FIG. 1 depicts an exemplary roll-off truck;

FIG. 2 depicts an exemplary roll-off truck;

FIG. 3 depicts an exemplary hoist of a roll-off truck;

FIG. 4 depicts steps for loading a container onto a roll-off truck;

FIG. 5 depicts a roll-of truck in accordance with the present invention;

FIG. 6 depicts a washout container in accordance with the present invention;

FIG. 7 depicts a vacuum module in accordance with the present invention;

FIG. 8 depicts an exemplary cradle and liner in accordance with the present invention

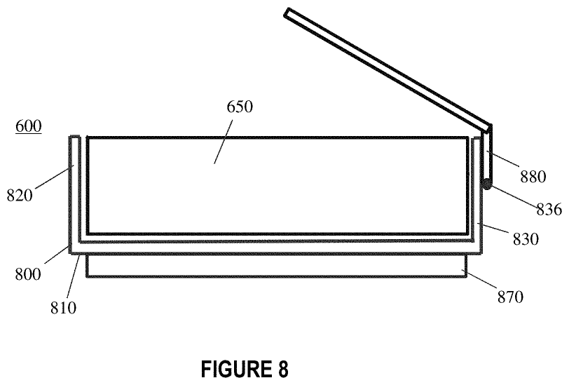

FIGS. 9A and 9B depict and exemplary cradle in accordance with the present invention;

FIG. 10 depicts an exemplary liner in accordance with the present invention.

FIGS. 11A-11D depict exemplary cradle member cross-sections.

FIG. 12 depicts an exemplary liner and exemplary cradle.

FIG. 13 depicts an exemplary liner and exemplary cradle.

### DETAILED DESCRIPTION OF THE INVENTION

The invention may be understood more readily by reference to the following detailed descriptions of embodiments of the invention. However, structures, systems, and techniques in accordance with the invention may be embodied in a wide variety of forms and modes, some of which may be quite different from those in the disclosed embodiments. Also, the features and elements disclosed herein may be combined to form various combinations without exclusivity, unless expressly stated otherwise. Consequently, the specific structural and functional details disclosed herein are merely representative. Yet, in that regard, they are deemed to afford the best embodiments for purposes of disclosure and to provide a basis for the claims herein, which define the scope of the invention. It must be noted that, as used in the specification and the appended claims, the singular forms “a”, “an”, and “the” include plural referents unless the context clearly indicates otherwise.

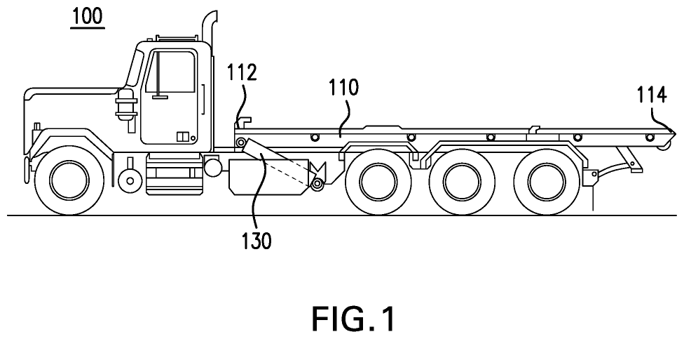

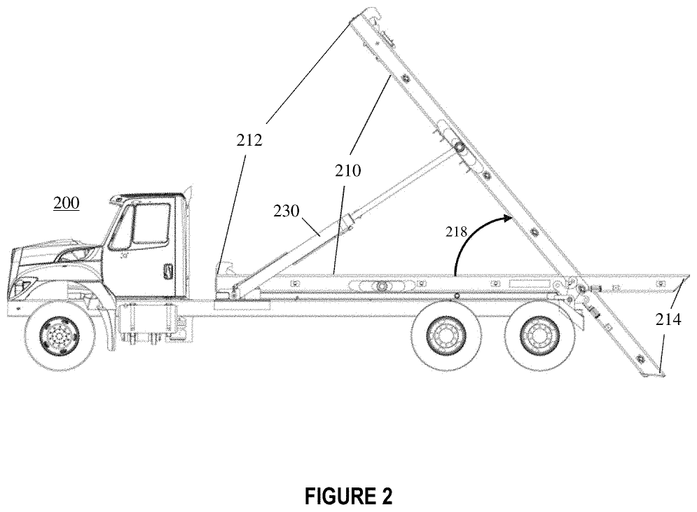

FIG. 1 depicts roll-off truck (100). The rear portion of roll-off truck (100) includes hoist (110). Hoist (110) extends from a front end (112) to a back end (114). FIG. 2 depicts a second example of a roll-off truck (200). The rear portion of roll-off truck (200) includes hoist (210). Hoist (210) also extends from a front end (212) to a back end (214). Hoist (210) is shown in FIG. 2 in a lowered position and in an alternate raised position wherein hoist (210) is raised by angle (218). Roll-off trucks (100, 200) each include one or more lifts, such as hydraulic lifts (130, 230), that may be used to raise the front end (112, 212) of hoist (110, 210).

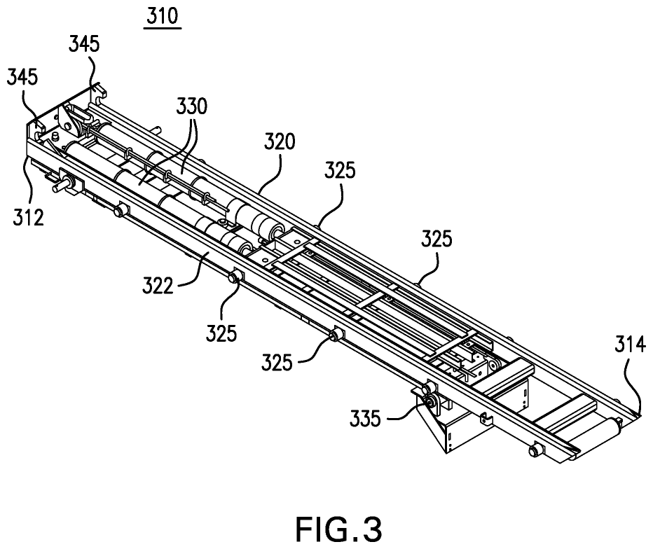

Another exemplary hoist (310) is depicted in FIG. 3. Hoist (310) extends from a front end (312) to a back end (314). When installed on a roll-off truck, hydraulic lifts (330) attached to hoist (310) may be used to raise the front end (312) of hoist (310). As front end (312) of hoist (310) is raised, it pivots about hinge (335) so that, as shown in FIG. 2, back end (314) of hoist (310) is lowered toward the ground.

Hoist (310) includes hoist rails (320, 322) that extend from the front end (312) or hoist (310) to the back end (314) of hoist (310). Each rail (320, 322) has a set of rollers (325) that help facilitate loading and unloading containers from hoist (310). The rollers (325) as shown in FIG. 3 are positioned on the outer facing surfaces of rails (320, 322). In addition or in the alternative, rollers may be positioned on one or both of the inner facing surfaces of rails (320, 322). Hoist (310) may also include stops (345) that can be used to help secure a container (not shown) to hoist (310).

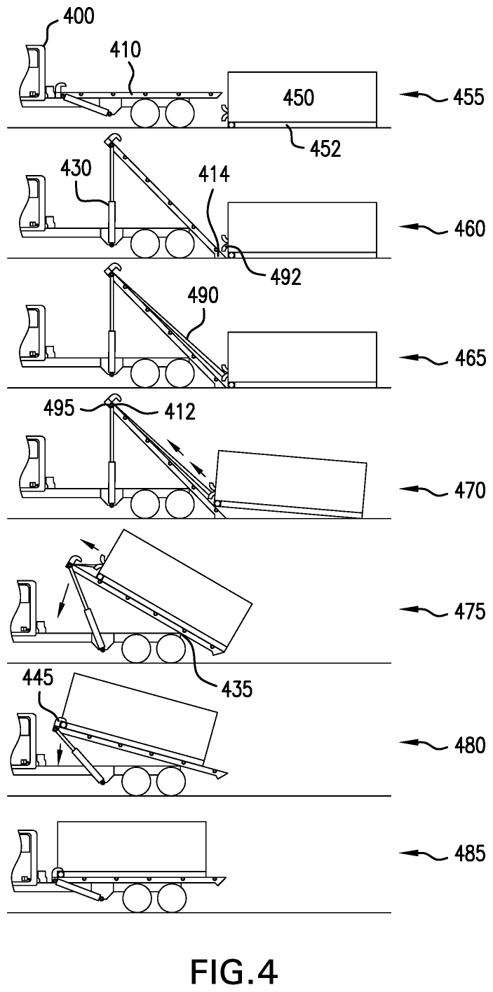

A container (450) may be loaded onto a roll-off truck (400) according to the steps shown in FIG. 4. The container may rest on container sills (452) that are aligned parallel to the rails of hoist (410). At step (455), roll-off truck (400) may be backed up to container (450) to be loaded. The rails of hoist (410) are preferably aligned with sill on the container. At step (460), the hoist may be raised using a lift (430) until back end (414) of hoist (410) touches the ground. At step (465), a cable (490) is attached to a connection point (492) (e.g. hook, loop) on container (450). Cable (490) may be a metal braided cable. At step (470), roll-off truck (400) may be allowed to roll under container (450). A winch (495) located at the front end (412) of hoist (410) may be used to pull container (450) onto hoist (410). Container sills (452) are preferably kept on the hoist rollers while container (450) is pulled onto hoist (410). At step (475), once the center of gravity of the container is in front of the rear hinge (435), hoist (410) may be lowered. At step (480), cable (90) and winch (495) may be used to continue pulling container (450) forward until it is securely locked into front stops (445). At step (485), hoist (410) may be lowered to a horizontal position (i.e. parallel to the ground).

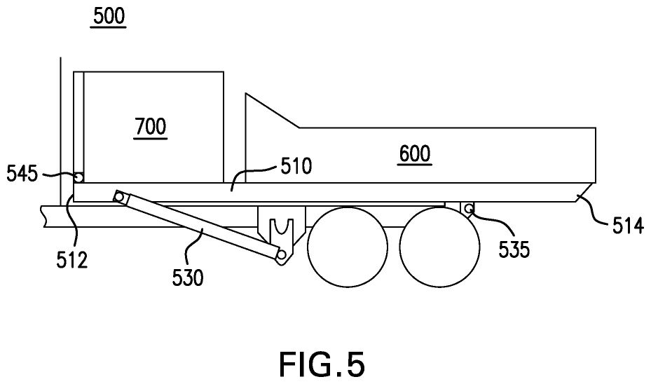

A roll-off truck (500) according to the present invention is shown in FIG. 5. Similar to the roll-off trucks described above, roll-off truck (500) includes hoist (510) that extends from front end (512) to back end (514). Hoist (510) may be approximately twenty-two feet long. Roll-off truck (500) may include lift (530), that may be used to raise front end (512) of hoist (510) and pivot hoist (510) about hinge (535), thereby lowering back end (514) of hoist (510). A winch and cable (not shown) may be located, for example, at front end (512) of hoist (510) and may be used to load a container (600) onto hoist (510).

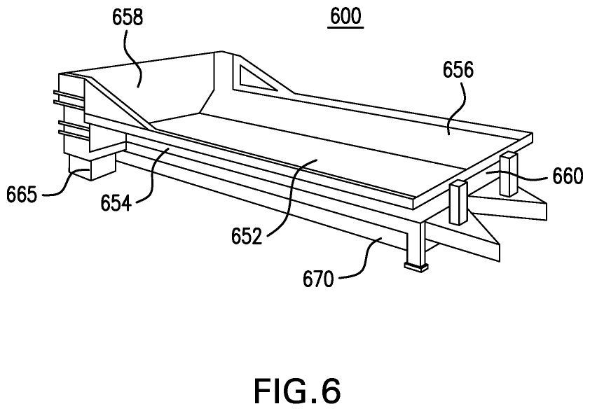

FIG. 6 depicts an exemplary container (600) used to collect concrete washout according to the present invention. Container (600) may have a bottom (652), left side (654), right side (656), front side (658), and back side (660). Left side (654) may be parallel to right side (656). Front side (658) may be parallel to back side (660). Front side (658) of container (600) may be higher than back side (660) of container (600) to help prevent splashing while wash-out is placed in container (600) and/or to help prevent wash-out from spilling out of container (600) as container (600) is loaded onto roll-off truck (500).

The bottom (652) and sides (654, 656, 659, and 660) of container (600) may be formed from a metal, such as steel, or from another material such as plastic. The sides (654, 656, 659, and 660) may be vertical, each attached at a 90-degree angle to the bottom. Alternatively, to facilitate emptying container (600), as shown in FIG. 6, one or more sides of container (600) may slope outward (attached at an angle to the bottom (652) of the container (600) at an angle greater than 90 degrees). If one or more sides slope outward, at some height above the bottom (652) of container (600), each wall may slope inward at a different angle or at a vertical angle. Alternatively, one or more sides may extend vertically from the bottom (652) of container (600), and then at some height above the bottom (652) of container (600), slope outward.

The top of container (600) may be open. Alternatively, a cover (not shown) may be placed on top of container (600). The cover may be formed from the same material as the sides. Alternatively, the cover may be formed from a different material, such as a fabric sheet. Container (600) may be, for example, approximately 16 feet long, from front side (658) to the back side (660).

To facilitate loading container (600) onto a roll-off truck and transporting container (600) by a roll-off truck, the underside of bottom (652) of container (600) may have sills (670). Sills (670) may be made from metal, such as steel. Sills (670) are preferably parallel to each other, and preferably parallel to left side (654) and right side (656) of container (600). The sills may be spaced so as to slide along rollers place along the rails of the hoist of a roll-off truck. Wheels may also be attached to the bottom (652) of container (600) and/or to sills (670) to facilitate loading the container (600) onto a roll-off truck, and unloading container (600) from the roll-off truck.

As shown further in FIG. 5, a roll-off truck (500) according to the present invention may further include a vacuum module (700). Vacuum module (700) may be loaded onto hoist (510) before container (600), and thereby placed on hoist (510), closer to the front end (512) of hoist (510) than container (600). In the alternative, vacuum module (700) may be loaded onto hoist (510) after container (600), and thereby placed on hoist (510) closer to the back end (514) of hoist (510). If vacuum module (700) is placed at the front end (512) of hoist (510), it may be secured to front stops (545).

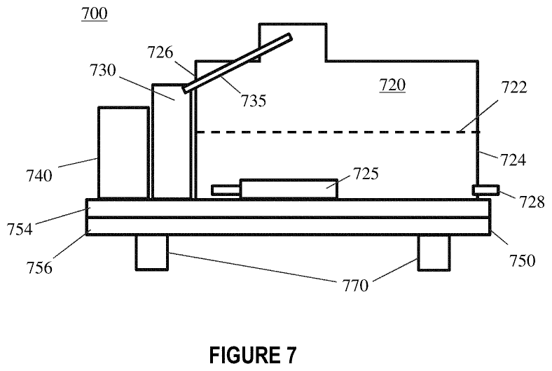

As shown in FIG. 7, vacuum module (700) may include vacuum tank (720), vacuum pump (730), and engine (740) to drive vacuum pump (730). Vacuum tank (720), vacuum pump (730), and engine (740) may be mounted on platform (750). Sills (770) may be attached to the underside of platform (750). Wheels may also be attached to platform (750) and/or to sills (770) to facilitate loading vacuum module (700) onto a roll-off truck, and unloading vacuum module (700) from the roll-off truck.

Platform (750) may consist of an upper layer (754) and a lower layer (756). Upper layer (754) and lower layer (756) may be joined by a bearing that allows upper layer (754) to rotate in a horizontal plane with respect to lower layer (756) so that when vacuum module (700) is loaded on a roll-off truck, vacuum tank (720) can be pointed to either side of the truck, to the front or back of the truck, or at any angle with respect to the truck.

Vacuum tank (720) may have a cylindrical shape with a longitudinal axis (722) running along the center line of vacuum tank (720). The front end (724) and back end (726) of the tank (720) may be flat, or may be curved (e.g. concave) to provide greater strength. A hose (not shown) extending from tank (720) may be used to vacuum liquid from container (600) to the tank (720). The vacuum (730) may attach to tank (720) by a flexible hose (735) or a pipe that connects at or near the top of tank (720). A flotation ball may be included within the tank. The flotation ball may rise as the liquid in the tank rises, and block the entrance to hose (735) when the liquid rises to the top of tank (720) to prevent liquid from being sucked into the vacuum. In addition or in the alternative, a check valve within tank (720) may prevent fluid from passing from tank (720) to the vacuum (730).

Tank (720) may include a valve (728) near the bottom of tank (720) at one end for emptying tank (720). In addition or in the alternative, one end (724, 726) of tank (720) may open as a door. The door may be hinged at or near the top of tank (720). A hydraulic cylinder (725) attached to tank (720) may raise one side of tank (720) to help empty the tank.

A hose may be connected between tank (720) and container (600). Vacuum pump (730) may be used to create negative pressure within tank (720), causing liquid residue from the container to tank (720) to be syphoned into tank (720). The liquid may be siphoned while container (600) is on the ground, or while container (600) is loaded on roll-off truck (500).

Vacuum module (700) may be loaded onto roll-off truck (500) using the method shown in FIG. 4 and described above. Roll-off truck (500) may be backed up to vacuum module (700) while vacuum module (700) is resting on the ground. The rails of hoist (510) are preferably aligned with sills (770) at the bottom of vacuum module (700). Hoist (510) may be raised using a lift (530) until back end (514) of hoist (510) approaches or touches the ground. A cable may be attached to a connection point (e.g. hook, loop) on vacuum module (700). The connection point may be attached to platform (750). Roll-off truck (500) may be allowed to roll under vacuum module (700). A winch located at the front end (512) of hoist (510) may be used to pull vacuum module (700) onto hoist (510). Sills (770) are preferably kept on rollers positioned to the side of the rails hoist (510) while vacuum module (700) is pulled onto hoist (510). Once the center of gravity of vacuum module (700) is in front of the rear hinge (535), hoist (510) may be lowered. A cable and winch may be used to continue pulling vacuum module (700) forward until it is securely locked into front stops (545). To the extent that wheels are attached to platform (750) and/or to sills (770), the wheels may be clamped to hoist (510). In addition or in the alternative, vacuum module (700) may be connected to hoist (510) by, for example, welding vacuum module (700) to hoist (510). As another example, one or more turnbuckles may be used to secure vacuum module (720) to hoist (510). Once vacuum module (720) is secured, the hoist (510) is fully lowered to a horizontal position (i.e. parallel to the ground).

When loaded on the roll-off truck (500), the longitudinal axis (722) of vacuum tank (720) may be oriented perpendicular to the longitudinal axis of hoist (510). In that case, sills or skids (770) beneath platform (750) may be oriented perpendicular to the longitudinal axis of vacuum tank (720) to facilitate sliding vacuum module (700) onto the truck bed.

Vacuum tank (720) may be oriented so that it may be emptied toward the driver side of the roll-off truck (500) or the passenger side of the roll-off truck (500). If vacuum pump (730) and engine (740) are placed to the side of vacuum tank (720) so that they are either on the side of vacuum tank (720) facing the front end (512) of hoist (510) or on the side of vacuum tank (720) facing the back end (514) of hoist (510), vacuum tank (720) may be designed so that it can be emptied on either side. For example, a drain or valve (728) may be placed at each side of the tank. In addition or in the alternative, one or both the ends (724, 726) of vacuum tank (720) may open to allow emptying of the tank. Two hydraulic cylinders may be placed so as to allow either side of vacuum tank (720) to be raised. For example, a sub-platform may be placed under vacuum tank (720). A first hydraulic cylinder attached to one end of the sub-platform may raise that side of the tank. A second hydraulic cylinder may attach the platform to the sub-platform and may raise the opposite side of the sub-platform.

After vacuum module (700) is loaded onto roll-off truck (500), container (600) may be loaded on roll-off truck (500) using the method shown in FIG. 4 and described above. The same cable and winch used to pull vacuum module (700) onto hoist (510) may be detached from vacuum module (720) and used to pull container (600) onto hoist (510). The cable may be passed under platform (750) and between sills (770), or between the components of vacuum module (700)—vacuum tank (720), vacuum pump (730), and engine (740)—to reach a connection point (e.g. hook, loop) attached to container (600). In the alternative, a passage may be left or formed in platform (750) through which the cable may pass.

At a construction site, washout container (600) may be placed on the ground where the wash-out is to be performed. One or more ramps (880) may be pivotally attached to cradle (800) by second hinge (836). Each ramp may have a first part (846) and a second part (848) attached, for example by a third hinge. When the ramp is extended and first part (846) is parallel and in line with second part (848), the hinge may be locked to form one long flat ramp. When not in use, the ramp(s) (880) may be folded so as to extend over the top of container (600). A crane (not shown) may be used to unfold the ramps (880). The crane may be attached to the roll-off truck that deposited container (600). When the ramp(s) (880) are unfolded, the top of the ramp(s) (880) may not reach the top of container (600). The portion of container (600) that extends above the top of the ramp(s) (880) may serve as a back stop to inhibit a truck from backing up too far and falling into container (600).

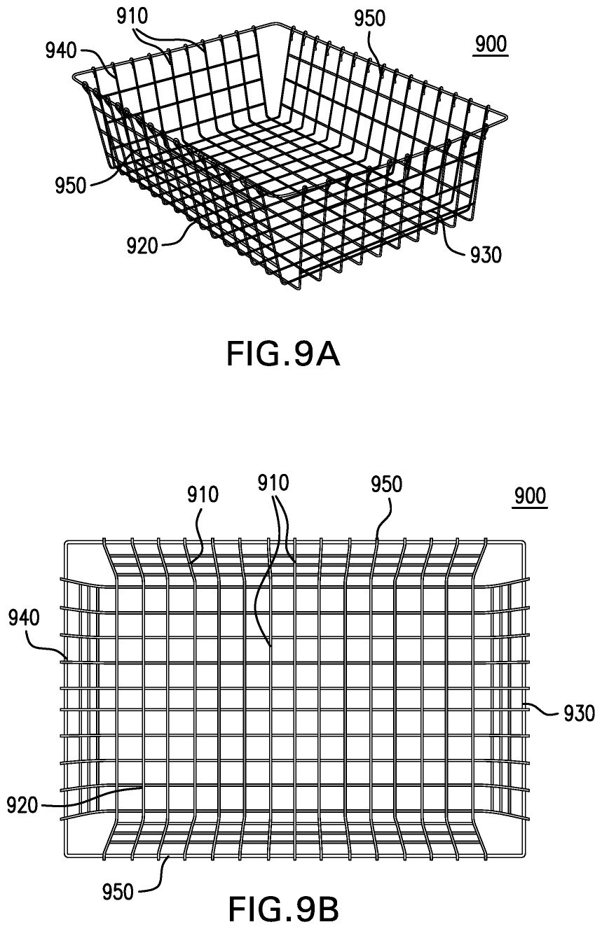

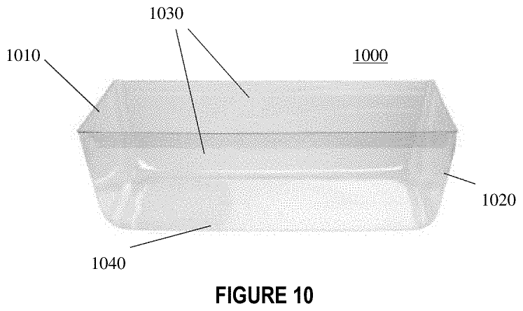

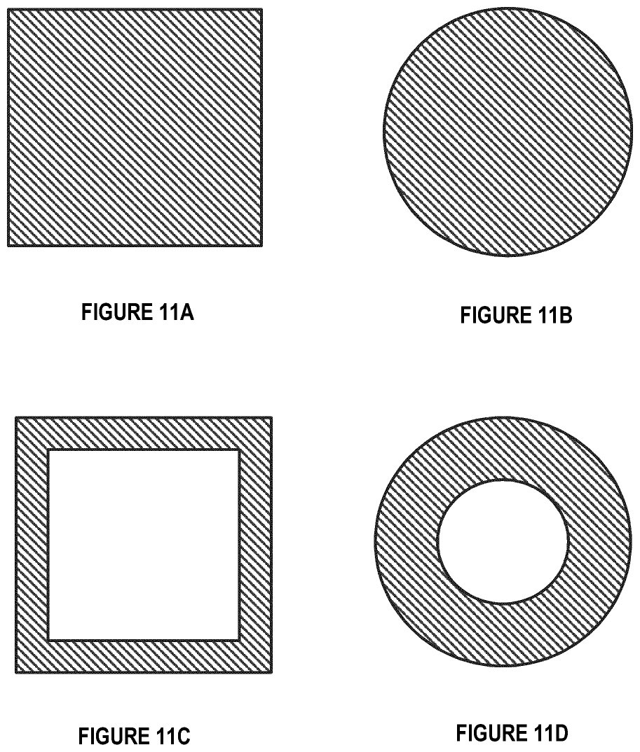

Referring to FIGS. 9A, 9B, and 10, instead of a washout container as depicted in FIG. 6, the washout container referenced above may comprise a cradle (900) and a liner (1000). As shown in FIGS. 9A and 9B, cradle (900) may be formed from members (910) (e.g., beams, joists, tubes, posts) spaced apart from each other. The members may be solid metal beams. The beams may have a rectangular cross-section or a circular cross-section as shown in FIGS. 11A and 11B, respectively. In the alternative, the members may be hollow metal pipes which have a rectangular cross-section or a circular cross-section as shown in FIGS. 11C and 11D, respectively.

The members may be arranged and connected so as to form a frame having a floor (920), a front wall (930), a rear wall (940), and right and left side walls (950). As shown in FIGS. 9a and 9B, the members may be positioned in an orthogonal arrangement so as to form a grid. In one embodiment, a first series of parallel members may be placed adjacent to but orthogonal to a second series of parallel members to form the floor (920) and/or one or more walls (930, 940, 950) of the cradle (900). In addition or in the alternative, for each of the floor (920) and/or one or more walls (930, 940, 950) a series of parallels members may be aligned in one direction with support members placed between and connecting the parallel members. The support members may be orthogonal to the parallel members and/or may be positioned at an angle to the parallel members. The spacing between parallel members which form each of the floor (920), a front wall (930), a rear wall (940), and side walls (950) may be the same.

Front wall (930) of cradle (900) may be higher than rear wall (940). In the alternative, rear wall (940) may be higher than front wall (930). Front wall (930), rear wall (940), and/or side walls (950) may be vertical in relation to bottom (920), each attached at a 90-degree angle to the bottom. Alternatively, to facilitate emptying the container, as shown in FIG. 9, one or more sides of cradle (900) may slope outward (attached at an angle to the bottom (920) of the cradle (900) at an angle greater than 90 degrees). If one or more sides slope outward, at some height above the bottom (920) of cradle (900), each wall may slope inward at a different angle or at a vertical angle. Alternatively, one or more sides may extend vertically from the bottom (920) of cradle (900), and then at some height above the bottom (920) of cradle (900), slope outward.

The top of cradle (900) may be open. Alternatively, a cover (not shown) may be placed on top of cradle (900). Cradle (900) may be, for example, approximately 16 feet long, from front side (930) to the back side (940). Sills (870) may be attached to the underside of cradle (900). Wheels may also be attached to the underside of cradle (900) and/or to sills (870) to facilitate loading cradle (900) onto a roll-off truck, and unloading cradle (900) from the roll-off truck.

Referring to FIG. 10, liner (650) may be formed from plastic. Liner (1000) may have a front wall (1010), a rear wall (1020), right and left side walls (1030), and a floor (1040). Preferably, front wall (1010), rear wall (1020), and side walls (1030) of liner (1000) are sloped at the same angle or angles as the corresponding front wall (930), rear wall (940), and side walls (950) of cradle (900).

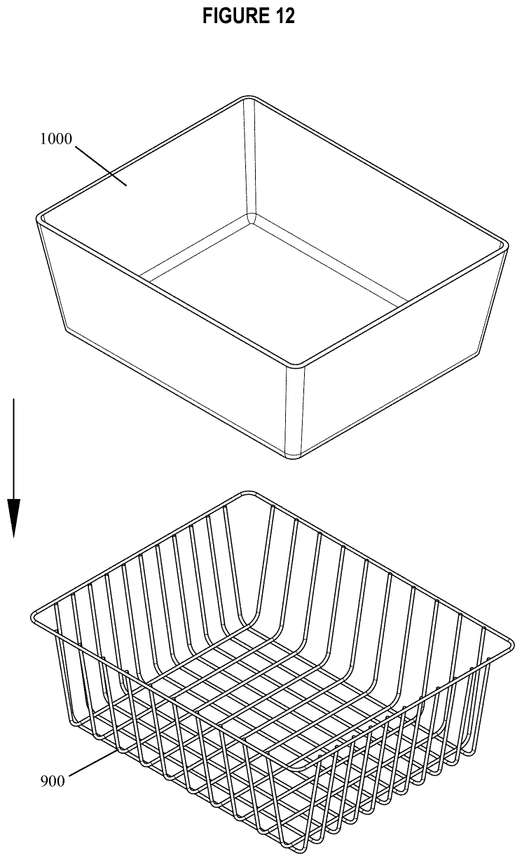

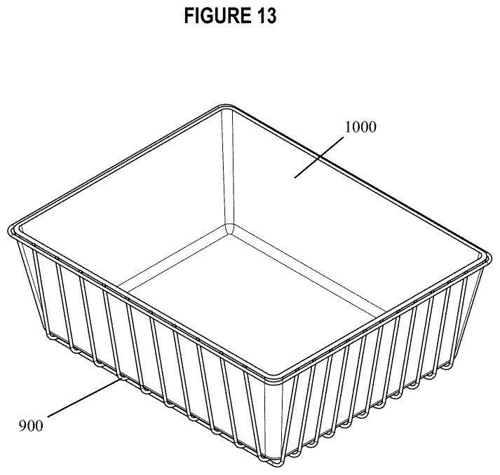

As shown in FIGS. 12 and 13, liner (1000) may be inserted into cradle (900). When inserted in cradle (900), liner (1000) may be held in place within the cradle using brackets such as angle brackets. Also, when inserted in cradle (900), the top of front wall (1010), rear wall (1020), and/or side walls (1030), of liner (1000) may match the height of front wall (930), rear wall (940), and side walls (950) of cradle (900). In the alternative, when inserted in cradle (900), the top of front wall (1010), rear wall (1020), and/or side walls (1030), of liner (1000) may be higher or lower than the height of front wall (930), rear wall (940), and side walls (950) of cradle (900).

While the invention has been described in detail with reference to embodiments for the purposes of making a complete disclosure of the invention, such embodiments are merely exemplary and are not intended to be limiting or represent an exhaustive enumeration of all aspects of the invention. It will be apparent to those of ordinary skill in the art that numerous changes may be made in such details, and the invention is capable of being embodied in other forms, without departing from the spirit, essential characteristics, and principles of the invention. Also, the benefits, advantages, solutions to problems, and any elements that may allow or facilitate any benefit, advantage, or solution are not to be construed as critical, required, or essential to the invention. The scope of the invention is to be limited only by the appended claims.

What is claimed is:

1. A washout container system comprising:
a roll-off truck having a hoist extending along a first longitudinal axis, said hoist comprising a first rail and a second rail; and
a container attached to the hoist;
wherein the container comprises a cradle and a liner, wherein the cradle has a bottom, a left side, a right side, a front side, and a rear side, and wherein the bottom of the cradle is formed by a plurality of beams spaced apart from each other.

2. The washout container system of claim 1, wherein the left side, right side, front side, and rear side of the cradle are each formed by a first series of parallel members placed adjacent to and orthogonal to a second series of parallel members.

3. The washout container system of claim 2, wherein the members are solid metal beams having a rectangular cross-section.

4. The washout container system of claim 2, wherein the members are solid metal beams having a circular cross-section.

5. The washout container system of claim 2, wherein the members are hollow metal pipes having a rectangular cross-section.

6. The washout container system of claim 2, wherein the members are hollow metal pipes having a circular cross-section.

7. The washout container system of claim 1, further comprising one or more angle brackets, wherein the liner is joined to the cradle by the one or more angle brackets.

8. The washout container system of claim 1, wherein the rear side of the cradle is higher than the front side.

9. The washout container system of claim 8, wherein the members are solid metal beams having a rectangular cross-section.

10. The washout container system of claim 8, wherein the members are solid metal beams having a circular cross-section.

11. The washout container system of claim 8, wherein the members are hollow metal pipes having a rectangular cross-section.

12. The washout container system of claim 8, wherein the members are hollow metal pipes having a circular cross-section.

13. The washout container system of claim 1, wherein the front side, rear side, left side, and right side of the cradle are joined to the floor of the cradle at 90 degrees.

14. The washout container system of claim 1, wherein the front side, rear side, left side, and right side of the cradle are joined to the floor of the cradle at an angle greater than 90 degrees.
